(19) United States
(12) Patent Application Publication
(10) Pub. No.: US 2026/0145180 A1
(43) Pub. Date: May 28, 2026

(54) COMBINED DEPRESSANT FOR SPHALERITE AND ITS APPLICATION

(71) Applicant: Kunming University of Science and Technology, Kunming (CN)

(72) Inventors: Dianwen Liu, Kunming (CN); Guohui Wang, Kunming (CN)

(21) Appl. No.: 19/369,552

(22) Filed: Oct. 27, 2025

(30) Foreign Application Priority Data
Nov. 22, 2024 (CN) 202411679937.6

(51) Int. Cl. B03D 1/018

(52) U.S. Cl. CPC B03D 1/018; B03D 2201/06; B03D 2203/02

(57) ABSTRACT

Discloses a combined depressant for sphalerite flotation separation and its application, the combined depressant including reducing substance and anthocyanin. It is used as a combined depressant for sphalerite in the flotation separation of chalcopyrite and sphalerite or galena and sphalerite. After crushing and grinding the raw ore, the combined collector and foaming agent are added to the ore pulp for copper-zinc or lead-zinc flotation. During the copper-zinc or lead-zinc separation process, the combined depressant is added as the sphalerite depressant, isopentyl xanthate is used as the collector of chalcopyrite or galena, pine oil is used as the foaming agent, the froth product is copper concentrate or lead concentrate, and the bottom product is zinc concentrate. The combined depressant of the disclosure has a strong inhibitory effect on sphalerite and can effectively achieve flotation separation of chalcopyrite and sphalerite or galena and sphalerite.

### CROSS-REFERENCE TO RELATED APPLICATIONS

This application claims to the benefit of priority from Chinese Application No. 202411679937.6 with a filing date of Nov. 22, 2024, the content of the aforementioned applications, including any intervening amendments thereto, are incorporated herein by reference.

### TECHNICAL FIELD

The disclosure relates to a combined depressant for sphalerite flotation separation and its application, belonging to the technical field of mineral processing reagents.

### BACKGROUND

With the increasing global demand for copper and lead as critical industrial metals, their indispensable role in modern applications has been further amplified. Due to their unique properties, copper and lead have become indispensable materials for modern life and are widely used in fields such as aerospace, machinery manufacturing, military chemical engineering, medical equipment, etc. The main sources of copper and lead are chalcopyrite and galena, which often coexist with sphalerite. In industrial production, in order to achieve complete separation of sphalerite and other sulfide ores, according to the flotation principle of “suppressing the majority to float the minority”, sphalerite is usually selectively suppressed, and chalcopyrite and galena are prioritized for floating.

Extensive research has been conducted on both inorganic and organic compounds for the selective separation of sphalerite from other sulfide ores. While cyanide and zinc sulfate remain the most widely used inorganic depressants for sphalerite, their application is limited by high toxicity and relatively poor inhibition efficiency. In contrast, organic depressants have gained prominence in copper-zinc and lead-zinc separations due to their advantages, including abundant availability, environmental compatibility, and superior selectivity. However, with the increasing proportion of low-grade sulfide ores in industrial production and the consequent complexity of mineral compositions, single organic depressants often fail to meet the flotation industry's demands for maximizing the comprehensive utilization of low-grade complex copper resources. Recent studies have demonstrated that synergistic combinations of organic depressants with inorganic compounds can leverage the respective strengths of each component. This approach capitalizes on multiple enhancement mechanisms, including synergistic interactions and solvent effects between different agents, thereby significantly improving the depressant performance on sphalerite.

### SUMMARY

The present disclosure aims to provide a method for efficient flotation separation of copper zinc and lead zinc minerals under reducing conditions, in order to solve the above-mentioned problems. The combined depressant of the present disclosure selectively depresses sphalerite, achieving copper zinc and lead zinc separation with stable performance.

A combined depressant for sphalerite provided by the present disclosure includes a reducing substance and anthocyanin, wherein the reducing substance is sodium sulfide or ferrous sulfate, the anthocyanin is one of cranberry extract, peanut skin extract, and grape seed extract, a mass ratio of the reducing substance to the anthocyanin depends on the reducibility strength of the reducing substance; a mass ratio of sodium sulfide with strong reducibility to anthocyanins is 0.5:1, and a mass ratio of ferrous sulfate with weak reducibility to anthocyanins is 2:1.

The present disclosure further provides an application of the combined depressant for sphalerite in the flotation separation of chalcopyrite and sphalerite or galena and sphalerite, steps are as follows:
(1) grinding primary ore of copper zinc sulfide ore or lead zinc sulfide ore, and then performing slurry mixing to obtain ore pulp to be floated;
(2) adding a combined collector and a foaming agent to the ore pulp to be floated in step (1) for mixed roughing operation, to obtain mixed roughing concentrate and mixed roughing tailings;
(3) performing two blank cleanings on the mixed rough concentrate obtained in step (2) to obtain a final mixed concentrate, the middlings from the two blank cleanings are sequentially returned to previous operation, forming a closed-loop cycle; adding a combined collector and a foaming agent sequentially to the mixed roughing tailings obtained in step (2) for mixed scavenging I, obtaining mixed scavenging I concentrate and mixed scavenging I tailings, adding a combined collector and a foaming agent sequentially to the mixed scavenging I tailings for mixed scavenging II, obtaining mixed tailings, the mixed scavenging I concentrate and mixed scavenging II concentrate are sequentially returned to previous operation, forming a closed-loop cycle;
(4) adding activated carbon powder to the mixed concentrate obtained in step (3) and grinding again, dewatering grinded product to obtain overflow and settling sand, the overflow returns to grinding operation in step (1), forming a closed-loop cycle, performing a separation operation the settling sand, adding a combined depressant, a collector, and a foaming agent sequentially to the settling sand for separation roughing operation, to obtain separated roughing concentrate and separated roughing tailings;
(5) adding a combined depressant, a collector, and a foaming agent to the separated roughing concentrate in step (4) in sequence for separated concentration operation I, obtaining separated concentration I concentrate and separated concentration I tailings, performing two blank cleanings on the separated concentration I concentrate to obtain a final concentrate, and middlings in two blank concentrations return to previous operation, forming a closed-loop cycle;
(6) adding a combined depressant, the collector, and the foaming agent to the separated roughing tailings in step (4) in sequence for a separated scavenging I operation to obtain separated scavenging I concentrate and separated scavenging I tailings, performing a separated scavenging II operation on the separated scavenging I tailings without adding reagents to obtain final zinc concentrate and separated scavenging II concentrate, the separated scavenging II concentrate is returned to previous operation, forming a closed-loop cycle.

The grinding conditions in step (1) of the present disclosure is: The primary ore is ground to a particle fineness of −0.074 mm, accounts for 64%-68% in step (1). The grinding conditions in step (4) of the present disclosure is: the mixed concentrate is ground to a particle fineness of −0.074 mm, accounting for 95%-98% in step (4).

In step (2), the combined collector is composed of ethyl xanthate and butyl xanthate, with a ratio of 3:5 for an addition of ethyl xanthate and butyl xanthate, and an addition amount of the combined collector is 40-120 g/t; and the foaming agent is No. 2 oil, with an addition amount of 10-25 g/t.

The combined collector of steps (2) and (3) described in the present disclosure is configured as a 1% mass concentration aqueous solution and added. In bulk flotation, the roughing operation takes 7-8 minutes, the scavenging operation takes 5-6 minutes, and the cleaning operation takes 6-7 minutes.

In step (4), the combined depressant is a reducing substance and anthocyanin. Isoamyl xanthate is used as a collector for chalcopyrite or galena, and pine oil is used as a foaming agent. The dosage of anthocyanin is 300-400 g/t, the dosage of reducing substance sodium sulfide is 150-200 g/t, the dosage of ferrous sulfate is 600-800 g/t, the dosage of isoamyl xanthate is 30-50 g/t, the dosage of pine oil is 20-25 g/t, and the dosage of activated carbon in step (4) is 300-500 g/t.

In step (5), the combined depressant is a reducing substance and anthocyanin. Isoamyl xanthate is used as a collector for chalcopyrite or galena, and pine oil is used as a foaming agent. The dosage of anthocyanin is 50-100 g/t, the dosage of reducing substance sodium sulfide is 25-50 g/t, the dosage of ferrous sulfate is 100-200 g/t, the dosage of isoamyl xanthate is 15-25 g/t, and the dosage of pine oil is 10-15 g/t.

In step (6), the combined depressant is a reducing substance and anthocyanin. Isoamyl xanthate is used as a collector for chalcopyrite or galena, and pine oil is used as a foaming agent. The dosage of anthocyanin is 150-200 g/t, the dosage of reducing substance sodium sulfide is 75-100 g/t, the dosage of ferrous sulfate is 300-400 g/t, the dosage of isoamyl xanthate is 20-30 g/t, and the dosage of pine oil is 15-20 g/t.

In the steps (4), (5), and (6) described in this disclosure, a combined depressant including reductive substance and anthocyanin is prepared as a 1-3% mass concentration aqueous solution and added, while xanthate is prepared as a 5% mass concentration aqueous solution and added. During the separation process: each roughing operation lasts 5-6 minutes, each scavenging operation lasts 4-5 minutes, and each cleaning operation lasts 5-6 minutes.

The addition of pine oil is according to the actual weight required for the ore quantity.

The principle of the present disclosure: The combined depressant of the present disclosure includes sodium sulfide, ferrous sulfate reducing substances, and anthocyanin. The present disclosure mainly utilizes the synergistic effect between reducing substances and anthocyanin to form a zinc sulfide combined depressant with the advantages of low dosage and strong adaptability to complex ores. Anthocyanins, as flavonoid compounds rich in hydroxyl groups, selectively adsorb onto metal sites on sulfide mineral surfaces, thereby increasing the mineral's hydrophilicity. However, during the flotation process, anthocyanins are prone to oxidation by substances including dissolved oxygen and metal ions present on mineral surfaces, which diminishes their reactivity. While increasing the anthocyanin dosage might counteract this issue, it simultaneously results in reduced selectivity. Therefore, adding reducing substances to the slurry for pre-reduction treatment can preserve the activity of anthocyanin and also cause reduction reactions on the mineral surface, exposing more metal active sites and promoting the adsorption of anthocyanin on the surface of sphalerite. When using isoamyl xanthate as a collector, chalcopyrite and galena exhibit good floatability, while sphalerite is still strongly inhibited, achieving the separation objective.

The advantageous effects of the present disclosure are:
(1) The combined depressant provided by the present disclosure is composed of reducing substances and anthocyanin. The combined depressant has the advantages of good water solubility, wide sources, and degradability, avoiding the problems of traditional inorganic depressant such as high toxicity and environmental pollution. The addition of reducing substances can reduce the amount of anthocyanin used, thereby lowering the cost of mineral processing.
(2) The combined depressant of the present disclosure is combined in a certain proportion as a sphalerite depressant, and is applied in the flotation separation of copper zinc sulfide and lead zinc through the synergistic effect between two agents. The separation effect is good, the concentrate grade is high, and it is of great significance for the efficient recovery and utilization of copper-lead-zinc sulfide ore.
(3) The reducing substance used in the present disclosure mainly provides a reducing environment, which is one of the reducing substances of sodium sulfide and ferrous sulfate. These substances are inexpensive and can be added to reduce the amount of anthocyanin used, lower the cost of reagents, and enhance the separation effect.

### BRIEF DESCRIPTION OF THE DRAWINGS

FIG. 1 is a process flowchart of an embodiment of the disclosure.

### DETAILED DESCRIPTION OF THE EMBODIMENTS

Embodiment 1: in the embodiment 1, a copper-zinc sulfide ore in Yunnan Province was studied by flotation separation experiments. The raw ore contained 0.90-1.00% of Cu and 1.60-1.80% of Zn. In the ore, copper mainly exists in the form of chalcopyrite, zinc mainly exists in the form of sphalerite, and gangue minerals mainly include quartz, dolomite, and feldspar.

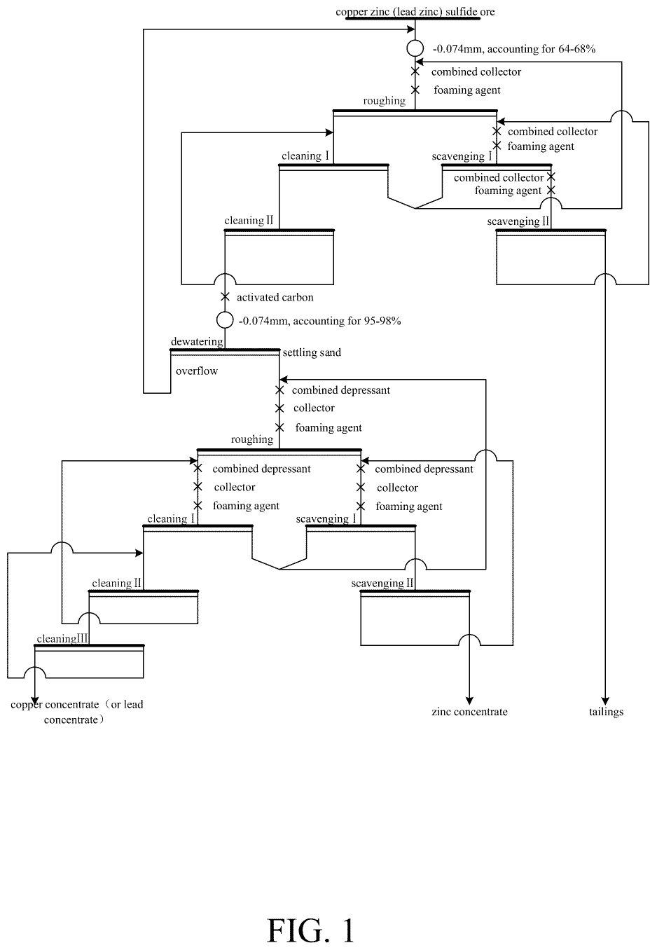

In embodiment 1-1, reducing substances of sodium sulfide and anthocyanin were used as a sphalerite depressant for copper zinc separation, with a mass ratio of 0.5:1. The flow chart is shown in FIG. 1, and the specific steps are as follows:
(1) crushing and ore grinding copper zinc sulfide ore until primary ore is ground to fineness of −0.074 mm, accounting for 64%, and obtaining the ore pulp to be floated;
(2) adding a copper zinc mineral combined collector and a foaming agent to the ore pulp to be floated in step (1) in sequence, performing a copper zinc mixed roughing operation for 7 minutes to obtain a copper zinc mixed roughing concentrate and a copper zinc mixed roughing tailings. The combined collector consists of ethyl xanthate and butyl xanthate, with a ratio of 3:5 and a dosage of 120 g/t. The dosage of foaming agent No. 2 oil is 25 g/t;
(3) performing blank cleaning of the copper zinc mixed roughing concentrate in step (2) twice, with each cleaning operation time lasting 6 minutes, to obtain the final copper zinc mixed concentrate. The middling of copper zinc mixed cleaning I and II are returned to the copper zinc mixed roughing and copper zinc mixed cleaning I respectively, forming a closed-loop cycle. Adding a combined collector to the copper zinc mixed roughing tailings at a dosage of 80 g/t, and the pine oil at a dosage of 15 g/t, and performing a copper zinc mixed scavenging I to obtaining mixed scavenging I concentrate and mixed scavenging I tailings. Then adding a combined collector to the copper zinc mixed scavenging I tailings at a dosage of 40 g/t, and pine oil at a dosage of 10 g/t, performing a copper zinc mixed scavenging II, and each scavenging operation time for 5 minutes to obtain the final tailings. The copper zinc mixed scavenging I concentrate and the copper zinc mixed scavenging II concentrate are respectively returned to copper zinc mixed roughing and copper zinc mixed scavenging I to form a closed-loop cycle;
(4) introducing the copper zinc mixed concentrate product obtained in the step (3) into a ball mill, and adding 500 g/t activated carbon powder to grind until the fineness is −0.074 mm, accounting for 95%, dewatering, overflowing and returning to the grinding operation before roughing, the settling sand enters the copper zinc separation operation. Adding 200 g/t sodium sulfide and 400 g/t anthocyanin as a sphalerite combined depressant, 30 g/t isopentyl xanthate as a collector, and 20 g/t pine oil as a foaming agent. Performing a separation and roughing operation for 5 minutes, and obtaining copper roughing concentrate and copper roughing tailings;
(5) adding 50 g/t sodium sulfide and 100 g/t anthocyanin as a sphalerite combined depressant, 15 g/t isoamyl xanthate as a collector, and 10 g/t pine oil as a foaming agent to the copper rough concentrate in step (4) for separation and cleaning operation I, obtaining separated cleaning I concentrate and separated cleaning I tailings. Performing twice blank cleaning on the separated cleaning I concentrate, with each cleaning operation lasting 5 minutes, to obtain the final copper concentrate. The tailings of copper cleaning I, II and III are respectively returned to copper roughing, copper cleaning I and copper cleaning II to form a closed-loop cycle. Adding 100 g/t sodium sulfide and 200 g/t anthocyanin as a sphalerite combined depressant, 20 g/t isopentyl xanthate as a collector, and 15 g/t pine oil as a foaming agent to the copper roughing tailings for separation scavenging I, obtaining separation scavenging I concentrate and separation scavenging I tailings. Performing one blank scavenging on the separation scavenging I tailings, with each scavenging lasting 4 minutes, to obtain the final zinc concentrate. The copper scavenging I and II concentrates are respectively returned to copper roughing and copper scavenging I to form a closed-loop cycle. The product indexes are shown in Table 1.

In embodiment 1-2, reducing substances of ferrous sulfate and anthocyanin were used as a sphalerite combined depressant for copper zinc separation, with a mass ratio of 2:1. In the copper zinc separation operation, the addition amounts of ferrous sulfate and anthocyanin for roughing, cleaning I, and scavenging I were 800 g/t and 400 g/t, 200 g/t and 100 g/t, and 400 g/t and 200 g/t, respectively. Other process conditions remain unchanged, and the product indexes are shown in Table 1.

Comparative example 1-3: conventional depressant zinc sulfate was used as a sphalerite depressant for copper zinc separation. In the copper zinc separation operation, the addition amounts of zinc sulfate for roughing, cleaning I, and scavenging I were 1000 g/t, 400 g/t, and 700 g/t. Other process conditions remained unchanged, and the product indexes are shown in Table 1.

Comparative example 1-4: single anthocyanin was used as a sphalerite depressant for copper zinc separation. In the copper zinc separation operation, the addition amounts of anthocyanin for roughing, cleaning I, and scavenging I were 500 g/t, 200 g/t, and 300 g/t, respectively. Other process conditions remained unchanged, and the product indexes are shown in Table 1.

TABLE 1
flotation separation results of embodiment 1

| | | | grade/% | | recovery rate/% | |
|---|---|---|---|---|---|---|
| types of depressants | product | productivity/% | Cu | Zn | Cu | Zn |
| sodium sulfide + | copper concentrate | 3.34 | 22.03 | 4.17 | 80.86 | 8.60 |
| anthocyanin | zinc concentrate | 2.87 | 3.56 | 47.53 | 11.23 | 84.20 |
| | tailings | 93.79 | 0.08 | 0.12 | 7.91 | 7.20 |
| | total | 100.00 | 0.91 | 1.62 | 100.00 | 100.00 |
| ferrous sulfate + | copper concentrate | 3.31 | 22.26 | 4.27 | 79.23 | 8.62 |
| anthocyanin | zinc concentrate | 2.82 | 3.86 | 48.85 | 11.70 | 84.00 |
| | tailings | 93.87 | 0.09 | 0.13 | 9.07 | 7.38 |
| | total | 100.00 | 0.93 | 1.64 | 100.00 | 100.00 |
| zinc sulfate | copper concentrate | 5.12 | 15.23 | 10.87 | 82.08 | 33.53 |
| | zinc concentrate | 2.62 | 3.68 | 40.69 | 10.15 | 64.22 |
| | tailings | 92.26 | 0.08 | 0.04 | 7.77 | 2.25 |
| | total | 100.00 | 0.95 | 1.66 | 100.00 | 100.00 |
| single anthocyanin | copper concentrate | 3.89 | 17.96 | 7.35 | 75.12 | 17.43 |
| | zinc concentrate | 2.74 | 5.62 | 44.24 | 16.56 | 73.91 |
| | tailings | 93.37 | 0.08 | 0.15 | 8.32 | 8.65 |
| | total | 100.00 | 0.93 | 1.64 | 100.00 | 100.00 |

From Table 1, it can be seen that the grade and the recovery rate of copper in the copper concentrate of the single anthocyanin increased by 2.73 percentage points and 4.74 percentage points, and the grade of zinc in the copper concentrate decreased by 3.52 percentage points compared with the depressant of zinc sulfate under the condition that the dosage of agent was the lowest; compared with the single depressant of anthocyanin, the grade and the recovery rate of copper in the copper concentrate of the combined depressant have increased. The grade and the recovery rate of copper in the copper concentrate of the combined depressant of sodium sulfide and anthocyanin have increased by 4.07 percentage points and 5.74 percentage points, respectively. The grade and the recovery rate of copper in the copper concentrate of the combined depressant of the ferrous sulfate and anthocyanin have increased by 4.3 percentage points and 4.11 percentage points, respectively, the grade of zinc in the copper concentrate has also decreased, And the combined depressant of the sodium sulfide and anthocyanin decreased by 3.18 percentage points, and the combined depressant of the ferrous sulfate and anthocyanin decreased by 3.08 percentage points. This indicates that the addition of reducing substances can strengthen the inhibition of sphalerite by anthocyanin and improve the recovery rate of copper.

Embodiment 2: in the embodiment 2, a lead-zinc sulfide ore in Yunnan Province was studied by flotation separation experiments. The raw ore contained 3.05-3.15% of Pb and 4.40-4.50% of Zn. In the ore, lead mainly exists in the form of galena, zinc mainly exists in the form of sphalerite, and gangue minerals mainly include quartz, dolomite.

In embodiment 2-1, reducing substances of sodium sulfide and anthocyanin were used as a galena depressant for lead zinc separation, with a mass ratio of 1:2. The flow chart is shown in FIG. 1, and the specific steps are as follows:
(1) crushing and ore grinding primary ore to fineness of −0.074 mm, accounting for 68%, and obtaining the ore pulp to be floated;
(2) adding lead zinc mineral combined collector with a dosage of 120 g/t and foaming agent No. 2 oil with a dosage of 25 g/t into the ore pulp to be floated, and performing lead zinc mixed roughing for 8 minutes to obtain lead zinc mixed roughing concentrate and lead zinc mixed coarse tailings;
(3) performing two blank cleanings of the lead zinc mixed roughing concentrate in step (2) twice, with each cleaning operation time lasting 7 minutes, to obtain the final lead zinc mixed concentrate. The concentrates of lead zinc mixed cleaning I and II are respectively returned to lead zinc mixed roughing and lead zinc mixed cleaning I to form a closed-loop cycle. Adding a combined collector to the lead zinc mixed roughing tailings at the dosage of 80 g/t and the pine oil at a dosage of 15 g/t, performing a lead zinc mixed scavenging I to obtain lead zinc mixed scavenging I concentrate and lead zinc mixed scavenging I tailings; then adding a combined collector at a dosage of 40 g/t and the pine oil at a dosage of 10 g/t to the lead zinc mixed scavenging I tailings, performing a lead zinc mixed scavenging II, with each scavenging operation lasting for 6 minutes to obtain the final tailings. The lead zinc mixed scavenging I and II concentrates are returned to the lead zinc mixed roughing and lead zinc mixed scavenging I respectively, forming a closed-loop cycle;
(4) introducing the lead zinc mixed concentrate product into a ball mill and adding 500 g/t activated carbon powder to grind until the fineness is −0.074 mm, accounting for 98%, dewatering, overflowing and returning to the grinding operation before roughing, the settling sand enters the lead zinc separation operation. Performing lead zinc separation flotation operation, adding 150 g/t sodium sulfide and 300 g/t anthocyanin as a sphalerite combined depressant, 50 g/t isopentyl xanthate as a collector, and 25 g/t pine oil as a foaming agent, performing one roughing, with the roughing operation time lasting 6 minutes, and obtaining the lead roughing concentrate and lead roughing tailings;
(5) 25 g/t sodium sulfide and 50 g/t anthocyanin as a sphalerite combined depressant, 25 g/t isoamyl xanthate as a collector, and 15 g/t pine oil as a foaming agent to the lead roughing concentrate in step (4) for lead cleaning I; performing blank cleaning on the lead cleaning I concentrate twice, with each cleaning operation lasting 6 minutes, to obtain the final lead concentrate. The concentrates of the lead cleanings I, II, and III are respectively returned to lead roughing, lead cleaning I, and lead cleaning II to form a closed-loop cycle. Adding 75 g/t sodium sulfide and 150 g/t anthocyanin as a sphalerite combined depressant, 30 g/t isopentyl xanthate as a collector, and 20 g/t pine oil as a foaming agent to the lead roughing tailings for lead scavenging I; performing a blank scavenging on the lead scavenging I tailings, with each scavenging lasting 5 minutes to obtain the final zinc concentrate. The lead scavenging I and II concentrates are respectively returned to lead roughing and lead scavenging I, forming a closed-loop cycle. The product indexes are shown in Table 2;

In embodiment 2-2, reducing substances of ferrous sulfate and anthocyanin were used as a sphalerite combined depressant for copper zinc separation, with a mass ratio of 2:1. In the copper zinc separation operation, the addition amounts of ferrous sulfate and anthocyanin for roughing, cleaning I, and scavenging I were 600 g/t and 300 g/t, 100 g/t and 50 g/t, 300 g/t and 150 g/t, respectively. Other process conditions remain unchanged, and the product indexes are shown in Table 2;

Comparative example 2-3: conventional depressant zinc sulfate was used as a sphalerite depressant for lead zinc separation, In the lead zinc separation operation, the addition amounts of the zinc sulfate roughing, cleaning I, and scavenging I were 1000 g/t, 400 g/t, and 700 g/t. Other process conditions remained unchanged, and the product indexes are shown in Table 2;

Comparative example 2-4: single anthocyanin was used as a lead separation. In the lead zinc sphalerite depressant for copper separation operation, the addition amounts of anthocyanin for roughing, cleaning I, and scavenging I were 100 g/t, 100 g/t, and 200 g/t, respectively. Other process conditions remained unchanged, and the product indexes are shown in Table 2;

TABLE 2
flotation separation results of embodiment 2

| | | | grade/% | | recovery rate/% | |
|---|---|---|---|---|---|---|
| types of depressants | product | productivity/% | Pb | Zn | Pb | Zn |
| sodium sulfide + | lead concentrate | 3.56 | 73.29 | 7.40 | 84.71 | 5.93 |
| anthocyanin | zinc concentrate | 10.55 | 2.19 | 35.48 | 7.50 | 84.30 |
| | tailings | 85.89 | 0.28 | 0.50 | 7.79 | 9.76 |
| | total | 100.00 | 3.08 | 4.44 | 100.00 | 100.00 |
| ferrous sulfate + | lead concentrate | 3.50 | 74.35 | 7.38 | 83.94 | 5.77 |
| anthocyanin | zinc concentrate | 10.43 | 2.21 | 36.48 | 7.44 | 84.93 |
| | tailings | 86.07 | 0.31 | 0.48 | 8.62 | 9.30 |
| | total | 100.00 | 3.10 | 4.48 | 100.00 | 100.00 |
| zinc sulfate | lead concentrate | 3.75 | 66.98 | 10.76 | 81.29 | 9.05 |
| | zinc concentrate | 12.13 | 2.88 | 30.19 | 11.31 | 82.11 |
| | tailings | 84.12 | 0.27 | 0.47 | 7.41 | 8.84 |
| | total | 100.00 | 3.09 | 4.46 | 100.00 | 100.00 |
| single anthocyanin | lead concentrate | 3.64 | 70.64 | 9.53 | 83.76 | 7.80 |
| | zinc concentrate | 11.42 | 2.41 | 32.14 | 8.96 | 82.48 |
| | tailings | 84.94 | 0.26 | 0.51 | 7.28 | 9.72 |
| | total | 100.00 | 3.07 | 4.45 | 100.00 | 100.00 |

From Table 2, it can be seen that the grade and the recovery rate of lead in lead concentrate of single anthocyanin increased by 3.66 percentage points and 2.47 percentage points, respectively, and the grade of zinc in lead concentrate decreased by 1.23 percentage points compared with the depressant of zinc sulfate under the condition that the dosage of agent was the lowest, indicating that the depressant effect of single anthocyanin on sphalerite is not as good as that of zinc sulfate; compared with the single anthocyanin depressant, the grade and recovery rate of lead in lead concentrate of the combined depressant have increased. The grade and recovery rate of lead in lead concentrate of the combined depressant of the sodium sulfide and the anthocyanin have increased by 2.65 percentage points and 0.77 percentage points, respectively. The grade and recovery rate of lead in lead concentrate of the combined depressant of the ferrous sulfate and the anthocyanin have increased by 3.71 percentage points and 0.18 percentage points, respectively, and the grade of zinc in the lead concentrate has also decreased. The combined depressant of the sodium sulfide and the anthocyanin decreased by 2.13 percentage points, and the combined depressant of the ferrous sulfate and the anthocyanin decreased by 2.15 percentage points, indicating that the addition of reducing substances can strengthen the inhibition of sphalerite by anthocyanin and improve the recovery rate of lead.

Embodiment 3: in the embodiment 3, a copper zinc sulfide ore in Inner Mongolia was studied by flotation separation experiments. The raw ore contained 2.90-3.00% of Cu and 1.7-1.8% of Zn. In the ore, lead mainly exists in the form of galena, zinc mainly exists in the form of sphalerite, and gangue minerals mainly include quartz, pyroxene, garnet, and feldspar.

In embodiment 3-1, reducing substances of sodium sulfide and anthocyanin were used as a sphalerite depressant for copper zinc separation, with a mass ratio of 0.5:1. The flow chart is shown in FIG. 1, and the specific steps are as follows:
(1) crushing and ore grinding copper zinc sulfide ore until primary ore is ground to fineness of −0.074 mm, accounting for 66%, and obtaining the ore pulp to be floated;
(2) adding a copper zinc mineral combined collector and a foaming agent to the ore pulp to be floated in step (1) in sequence, performing a copper zinc mixed roughing operation for 7 minutes to obtain a copper zinc mixed roughing concentrate and a copper zinc mixed roughing tailings. The combined collector consists of ethyl xanthate and butyl xanthate, with a ratio of 3:5 and a dosage of 120 g/t. The dosage of foaming agent No. 2 oil is 25 g/t;
(3) performing blank cleaning of the copper zinc mixed roughing concentrate in step (2) twice, with each cleaning operation time lasting 6 minutes, to obtain the final copper zinc mixed concentrate. The middling of copper zinc mixed cleaning I and II are returned to the copper zinc mixed roughing and copper zinc mixed cleaning I respectively, forming a closed-loop cycle. Adding a combined collector to the copper zinc mixed roughing tailings at a dosage of 80 g/t, and the pine oil at a dosage of 15 g/t, and performing a copper zinc mixed scavenging I to obtaining mixed scavenging I concentrate and mixed scavenging I tailings. Then adding a combined collector to the copper zinc mixed scavenging I tailings at a dosage of 40 g/t, and pine oil at a dosage of 10 g/t, performing a copper zinc mixed scavenging II, and each scavenging operation time for 5 minutes to obtain the final tailings. The copper zinc mixed scavenging I concentrate and the copper zinc mixed scavenging II concentrate are respectively returned to copper zinc mixed roughing and copper zinc mixed scavenging I to form a closed-loop cycle;
(4) introducing the copper zinc mixed concentrate product obtained in the step (3) into a ball mill, and adding 500 g/t activated carbon powder to grind until the fineness is −0.074 mm, accounting for 97%, dewatering, overflowing and returning to the grinding operation before roughing, the settling sand enters the copper zinc separation operation. Adding 175 g/t sodium sulfide and 350 g/t anthocyanin as a sphalerite combined depressant, 40 g/t isopentyl xanthate as a collector, and 22 g/t pine oil as a foaming agent. Performing a separation and roughing operation for 5 minutes, and obtaining copper roughing concentrate and copper roughing tailings;
(5) adding 40 g/t sodium sulfide and 80 g/t anthocyanin as a sphalerite combined depressant, 20 g/t isoamyl xanthate as a collector, and 12 g/t pine oil as a foaming agent to the copper rough concentrate in step (4) for separation and cleaning operation I, obtaining separated cleaning I concentrate and separated cleaning I tailings. Performing twice blank cleaning on the separated cleaning I concentrate, with each cleaning operation lasting 5 minutes, to obtain the final copper concentrate. The tailings of copper cleaning I, II and III are respectively returned to copper roughing, copper cleaning I and copper cleaning II to form a closed-loop cycle. Adding 90 g/t sodium sulfide and 180 g/t anthocyanin as a sphalerite combined depressant, 25 g/t isopentyl xanthate as a collector, and 17 g/t pine oil as a foaming agent to the copper roughing tailings for separation scavenging I, obtaining separation scavenging I concentrate and separation scavenging I tailings. Performing one blank scavenging on the separation scavenging I tailings, with each scavenging lasting 4 minutes, to obtain the final zinc concentrate. The copper scavenging I and II concentrates are respectively returned to copper roughing and copper scavenging I to form a closed-loop cycle. The product indexes are shown in Table 3.

In embodiment 3-2, reducing substances of ferrous sulfate and anthocyanin were used as a sphalerite combined depressant for copper zinc separation, with a mass ratio of 2:1. In the copper zinc separation operation, the addition amounts of ferrous sulfate and anthocyanin for roughing, cleaning I, and scavenging I were 700 g/t and 350 g/t, 160 g/t and 80 g/t, and 360 g/t and 180 g/t, respectively. Other process conditions remain unchanged, and the product indexes are shown in Table 3.

TABLE 3
flotation separation results of embodiment 3

| | | | grade/% | | recovery rate/% | |
|---|---|---|---|---|---|---|
| types of depressants | product | productivity/% | Cu | Zn | Cu | Zn |
| sodium sulfide + | copper concentrate | 9.68 | 24.31 | 2.29 | 80.31 | 12.74 |
| anthocyanin | zinc concentrate | 2.54 | 3.56 | 49.56 | 3.09 | 72.35 |
| | tailings | 87.78 | 0.55 | 0.30 | 16.60 | 14.91 |
| | total | 100.00 | 2.93 | 1.74 | 100.00 | 100.00 |
| ferrous sulfate + | copper concentrate | 9.73 | 24.39 | 2.31 | 80.45 | 12.63 |
| anthocyanin | zinc concentrate | 2.61 | 3.86 | 49.66 | 3.42 | 72.82 |
| | tailings | 87.66 | 0.54 | 0.30 | 16.14 | 14.56 |
| | total | 100.00 | 2.95 | 1.78 | 100.00 | 100.00 |

The above are only the preferred embodiments of the present disclosure and do not limit the present disclosure in any form. Any modifications made by those skilled in the art based on the technical essence of the present disclosure in various equivalent forms will fall within the scope of the claims attached to this application.

What is claimed is:

1. A combined depressant for sphalerite, comprising a reducing substance and anthocyanin, wherein the reducing substance is sodium sulfide or ferrous sulfate, and the anthocyanin is selected from cranberry extract, peanut skin extract, or grape seed extract, the mass ratio of the reducing substance to the anthocyanin depends on the reducibility strength of the reducing substance; a mass ratio of sodium sulfide with strong reducibility to anthocyanins is 0.5:1, and a mass ratio of ferrous sulfate with weak reducibility to anthocyanins is 2:1.

2. The combined depressant for sphalerite according to claim 1, wherein the combined depressant is used for flotation separation of chalcopyrite and sphalerite or galena and sphalerite.

3. An application of the combined depressant for sphalerite according to claim 1 in the flotation separation of chalcopyrite and sphalerite or galena and sphalerite, steps are as follows:
(1) grinding primary ore of copper zinc sulfide ore or lead zinc sulfide ore, and then performing slurry mixing to obtain ore pulp to be floated;
(2) adding a combined collector and a foaming agent to the ore pulp to be floated in step (1) for mixed roughing operation, to obtain mixed roughing concentrate and mixed roughing tailings;
(3) performing two blank cleanings on the mixed rough concentrate obtained in step (2) to obtain a final mixed concentrate, the middlings from the two blank cleanings are sequentially returned to previous operation, forming a closed-loop cycle; adding a combined collector and a foaming agent sequentially to the mixed roughing tailings obtained in step (2) for mixed scavenging I, obtaining mixed scavenging I concentrate and mixed scavenging I tailings, adding a combined collector and a foaming agent sequentially to the mixed scavenging I tailings for mixed scavenging II, obtaining mixed tailings, the mixed scavenging I concentrate and mixed scavenging II concentrate are sequentially returned to previous operation, forming a closed-loop cycle;
(4) adding activated carbon powder to the mixed concentrate obtained in step (3) and grinding again, dewatering grinded product to obtain overflow and settling sand, the overflow returns to grinding operation in step (1), forming a closed-loop cycle, performing a separation operation the settling sand, adding a combined depressant, a collector, and a foaming agent sequentially to the settling sand for separation roughing operation, to obtain separated roughing concentrate and separated roughing tailings;
(5) adding a combined depressant, a collector, and a foaming agent to the separated roughing concentrate in step (4) in sequence for separated concentration operation I, obtaining separated concentration I concentrate and separated concentration I tailings, performing two blank cleanings on the separated concentration I concentrate to obtain a final concentrate, and middlings in two blank concentrations return to previous operation, forming a closed-loop cycle;
(6) adding a combined depressant, the collector, and the foaming agent to the separated roughing tailings in step (4) in sequence for a separated scavenging I operation to obtain separated scavenging I concentrate and separated scavenging I tailings, performing a separated scavenging II operation on the separated scavenging I tailings without adding reagents to obtain final zinc concentrate and separated scavenging II concentrate, the separated scavenging II concentrate is returned to previous operation, forming a closed-loop cycle.

4. The application of the combined depressant for sphalerite in the flotation separation of chalcopyrite and sphalerite or galena and sphalerite according to claim 3, wherein the primary ore is ground to a particle fineness of −0.074 mm, accounts for 64%-68% in step (1); the mixed concentrate is ground to a particle fineness of −0.074 mm, accounting for 95%-98% in step (4).

5. The application of the combined depressant for sphalerite in the flotation separation of chalcopyrite and sphalerite or galena and sphalerite according to claim 3, wherein in step (2), the combined collector is composed of ethyl xanthate and butyl xanthate, with a ratio of 3:5 for an addition of ethyl xanthate and butyl xanthate, and an addition amount of the combined collector is 40-120 g/t; the foaming agent is pine oil, with an addition amount of 10-25 g/t.

6. The application of the combined depressant for sphalerite in the flotation separation of chalcopyrite and sphalerite or galena and sphalerite according to claim 3, wherein the combined depressant in step (4) is a reducing substance and anthocyanin, isoamyl xanthate is used as the collector for chalcopyrite or galena, and pine oil is used as the foaming agent, wherein an dosage of anthocyanin is 300-400 g/t, an dosage of reducing substance of sodium sulfide is 150-200 g/t, an dosage of ferrous sulfate is 600-800 g/t, an dosage of isoamyl xanthate is 30-50 g/t, an dosage of pine oil is 20-25 g/t, and an dosage of the activated carbon in step (4) is 300-500 g/t.

7. The application of the combined depressant for sphalerite in the flotation separation of chalcopyrite and sphalerite or galena and sphalerite according to claim 4, in step (5), the combined depressant is the reducing substance and the anthocyanin, isoamyl xanthate is used as the collector for chalcopyrite or galena, and pine oil is used as the foaming agent, wherein the dosage of anthocyanin is 50-100 g/t, the dosage of reducing substance of the sodium sulfide is 25-50 g/t, the dosage of ferrous sulfate is 100-200 g/t, the dosage of isoamyl xanthate is 15-25 g/t, and the dosage of pine oil is 10-15 g/t; in step (6), the combined depressant is the reducing substance and the anthocyanin, isoamyl xanthate is used as the collector for chalcopyrite or galena, and pine oil is used as the foaming agent, wherein the dosage of anthocyanin is 150-200 g/t, the dosage of reducing substance of sodium sulfide is 75-100 g/t, the dosage of ferrous sulfate is 300-400 g/t, the dosage of isoamyl xanthate is 20-30 g/t, and the dosage of pine oil is 15-20 g/t.
